(19) United States
(12) Patent Application Publication
(10) Pub. No.: US 2002/0072388 A1
(43) Pub. Date: Jun. 13, 2002

(54) Wireless multimode communication with timed affiliation

(76) Inventors: Jose E. Korneluk, Boynton Beach, FL (US); Thomas A. Murray, Lincoln, NE (US); George C. Anderson, Sunrise, FL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 09/733,831

(22) Filed: Dec. 11, 2000

(51) Int. Cl. H04B 1/38

(52) U.S. Cl. 455/551; 455/553

(57) ABSTRACT

A multi-mode wireless communication device (100) such as a cellular telephone. The communication device is capable of operating with a plurality of affiliations. A memory (110) contains timed affiliation profiles (111) for a plurality of timed affiliations (150, 160). Under control of a controller (112), time information broadcast over a system control channel is compared with information stored in memory (111) to determine which of a plurality of affiliations the communication device should be registered under. The controller (112) directs the communication device to register under a new affiliation or otherwise modify affiliations when a time associated with a timed affiliation profile (111) is reached.

### FIELD OF THE INVENTION

This invention relates generally to the field of wireless communication devices such as cellular and other wireless telephones and two-way radios. More particularly, in certain embodiments this invention relates to a multi-mode wireless communication device such as a multi-mode wireless telephone device having capability for multiple affiliations based upon time and date parameters.

### BACKGROUND OF THE INVENTION

Due to the recent proliferation of wireless communication devices, in many instances users carry multiple devices to satisfy multiple needs. For example, a person might need a cellular telephone in order to transact business, but might also desire a cellular telephone for personal use. This creates a burden on the user of potentially carrying multiple telephones, charging multiple sets of batteries, etc. Due to this burden, there is also the increased possibility of abuse of business accounts for personal use, or vice versa.

Often, the various needs of such users can be logically segregated in time so that only one device needs to be carried at any given time. However, this still creates the burden of remembering to switch telephones at the end of the work day, for example. This time segregation also does nothing to alleviate the need for multiple batteries, chargers, etc. There is thus, a need for users to be able to utilize such portable communication devices in a more flexible way to eliminate these burdens.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 shows a communication environment consistent with embodiments of the present invention.

FIG. 2 is a block diagram of a subscriber unit capable of operating under a plurality of timed affiliation profiles consistent with an embodiment of the present invention.

FIG. 3 is a flow chart describing high level operation of embodiments of the present invention.

FIG. 4 is a more detailed flow chart describing operation of an embodiment consistent with the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

For purposes of this document, the term “affiliation” refers to an association between a communication device and a service provided by a service provider. By way of example, and not by way of any limitation, this affiliation can be by virtue of system, phone number, protocol, NAM (Numeric Assignment Module), frequency, Identification code, TMSI (Temporary Mobile Station Identifier), LAI (Location Area Identity) or other information that determines an operational mode of the device within a particular system. Thus, changing of certain of the affiliation parameters can render a device operative or inoperative in a particular system, or may equivalently alter the associated billing information for use of the device within a system.

When a subscriber unit receives an incoming call, the communication system transmits source identification information along with the call. The incoming call can be a phone call from a telephone network, a private, or unit-to-unit call made directly from another subscriber unit, or a short message service or page call.

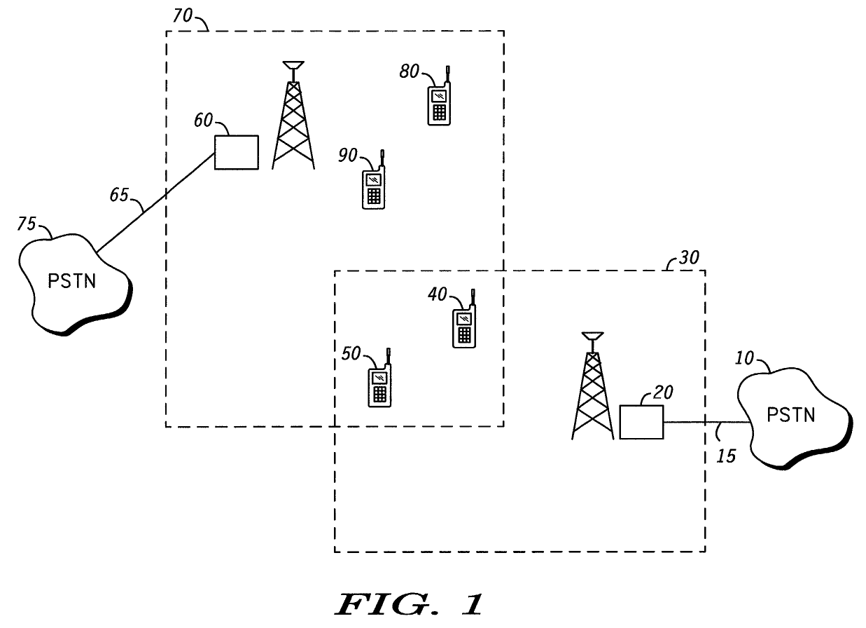

Referring to FIG. 1, a block diagram of communication system 30 is shown, and includes a plurality of mobile stations or subscriber units, including a first subscriber unit 40 and a second subscriber unit 50. The communication system may further include a first communication system infrastructure 20. The communication system 30 can be, for example, a two-way radio system or a cellular telephone system. The communication system infrastructure 20 is typically connected to a public switched telephone network (PSTN) 10 through communication link 15, such as a frame relay link. The communication link 15 allows subscriber units of communication system 30 to communicate over the PSTN. The first subscriber unit 40 can make a call to another subscriber unit, such as second subscriber unit 50. The call can be directly from one subscriber unit over the air to the other subscriber unit, or it may be facilitated by the communication infrastructure 20. Furthermore, the call can be a private call to a single other subscriber unit, or it can be to multiple other subscriber units. The second subscriber unit 50 receives notification of the call either from the infrastructure 20, or from first unit 40. The notification contains a source identifier (ID) of the caller that identifies the first subscriber unit 40 as the calling party to the second subscriber unit.

In an alternate embodiment, an external call initiated from PSTN 10 is directed towards first subscriber unit 40. The telephone network will send the call notification and source ID information over connection 15 to communication system 30, where infrastructure 20 will forward the call to the appropriate subscriber unit, such as first subscriber unit 40. Those skilled in the art will recognize the source ID information in this embodiment may be the so-called caller ID service provided by the operators of the PSTN 10. The first subscriber unit 40 receives notification of the call from infrastructure 20, and the notification contains the source ID of the caller, which typically includes the phone number of the external caller from telephone network 1 0.

As shown, communication system 30 includes subscriber units 40 and 50 that are said to be “affiliated” with system 30. Other communication systems can coexist in the same (or other) geographic areas. The communication system 70 is an example of a second communication system having infrastructure 60 that is typically connected to a public switched telephone network (PSTN) 75 through communication link 65, such as a frame relay link. Subscriber units 80 and 90 are affiliated with communication system 70 and the system operates in a manner identical or similar to that of system 30. PSTN 75 may be the same PSTN as PSTN 10, or alternatively, may be a separate system (e.g. a system in a different country or different geographic area). Subscriber units 40 and 50, as shown, are also capable of affiliation with system 70. Thus, subscriber units 40 and 50 in accordance with the present invention may have multiple affiliations as will be described.

In accordance with certain embodiments of the present invention, it is desirable for a subscriber unit to have the ability to function in multiple systems based upon a timed affiliation profile, as will be described. Thus a particular subscriber unit (e.g. 40 or 50), based upon a time of day, day of week, etc., may be affiliated with either one or both of systems 30 and 70. Moreover, in other embodiments of the present invention, timed affiliations can be changed within a single communication system. Thus, for example, a single subscriber unit (e.g. 40) could operate on an affiliation associated with a particular account or telephone number during business hours, while operating in accordance with another account or telephone number at other times.

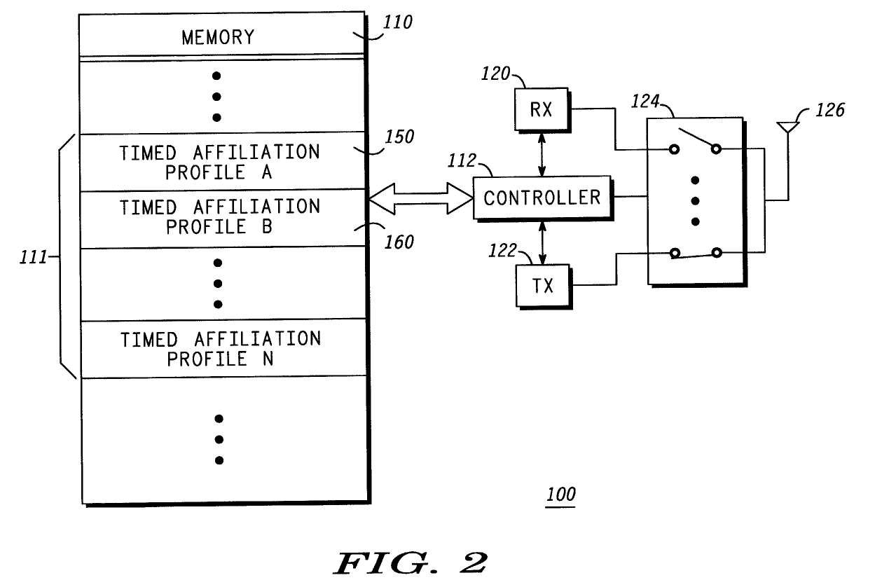

A block diagram of a typical subscriber unit 100, such as subscriber units 40 or 50, is shown in FIG. 2. Referring now to FIG. 2, a transceiver operating as a subscriber unit 100 includes a receiver 120 and transmitter 122, both electrically coupled to an antenna 126 via antenna switch 124, as is common in the art. Receiver 120 and transmitter 122 are both electrically coupled to controller 112, which may be, for example, a microprocessor or microcontroller for operating subscriber unit 100. Controller 112 operates according to instruction code stored in a memory 110. The memory also further contains timed affiliation profile information 111, including data and rules, as is described herein. In the preferred embodiment, the timed affiliation profile information is stored in a portion of memory 110 that is non-volatile and programmable to ensure the information is maintained when electrical power is removed from subscriber unit 100.

The multi-mode communication device 100 of FIG. 2 consistent with embodiments of the present invention includes a multimode transceiver that transmits and receives over the antenna 126. The transceiver, including transmitter 122 and receiver 120, operates under the control of controller 112 to operate in any of a number of designated modes of operation. Controller 112 is coupled by a bus or other suitable connection to the non-volatile memory device 110. Memory 110 includes data including timed affiliation profiles 111 for the communication device 100 enabling the communication device 100 to operate with any of several affiliations—A, B, . . . N. The timed affiliation profile for affiliation A is illustrated as profile 150 while the profile for affiliation B is illustrated as 160. Although two affiliations will be discussed for ease of understanding the present invention, the invention is not to be construed to be so limited since any number N of timed affiliation profiles could be stored in memory 110.

In the current exemplary embodiment, assume that only two affiliations are possible—A or B. The present invention permits the communication device 100 to operate in accordance with either of the two affiliations A or B in accordance with programmed parameters. For example, the multi-mode communication device 100 might be used for both business and personal use. For business use, affiliation A might represent a business account. All activity that takes place while affiliation A is the active affiliation is, therefore, charged to a business account. Affiliation B might represent a personal account. All activity that takes place while affiliation B is the active affiliation is, therefore, charged to a personal account. Affiliations A and B may have the same or different telephone numbers or other characteristics. In this example, it is irrelevant whether the business and personal accounts are established with the same service provider, so long as the multi-mode communication device 100 is capable of communication using both accounts. Thus, profiles A and B could include information identifying two accounts with the same service provider (thus using the same frequency band, protocol, etc. and simply switching NAMs), or could define operational parameters for two completely separate systems (possibly requiring different frequencies, protocols, NAMs, phone numbers, etc.).

In accordance with certain embodiments of the invention, the communication device 100's affiliation is determined by a programmed designation based on date and time. In the example shown, the communication device 100's controller 112 can be programmed to utilize the profile for affiliation A during business hours of business days, excluding holidays. Similarly, at other times and dates, the controller 112 can be programmed to utilize profile B. In this manner, a single communication device 100 can be used for both business and personal use, and the profile used for each affiliation is based on patterns of use associated with either business or personal use. Other patterns of use besides business and personal could also be used to control the affiliation profile in accordance with embodiments of the present invention.

The controller 112 can use date and time information from any suitable source including either an internal clock or from information periodically broadcast from the service provider. In the former case, the date and time information is stored locally within communication device 100 and is therefore always available. In the latter example, such information is often available on the BCCH (Broadcast Control Channel) used to broadcast system information messages to subscribers in a cellular system telephone. Current date and time information is, thus, readily available to the controller 112. For example, in Motorola's iDEN® system, the local time is broadcasted every 360 ms, and is thus readily available for use in conjunction with the timed affiliation profiles of the present invention.

For purposes of this invention, date information should be equivalently interpreted to include calendar date information, seven-day clock information and other information that provides controller 112 with an appropriate representation of the date for use in controlling the affiliation of the communication device 100.

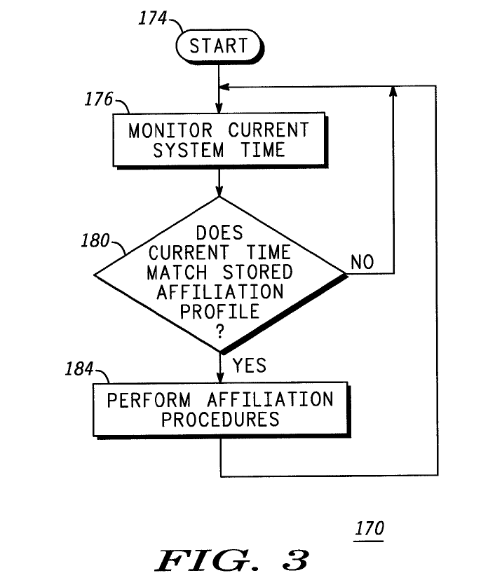

Referring now to FIG. 3, a flow chart 170 describes the overall process for timed affiliation in accordance with certain embodiments of the present invention. Process 170 starts at 174. The current system time is monitored at 176. This can be accomplished by an internal real time clock or by decoding a transmitted system time or any other suitable means. If the current time does not match a time in a stored affiliation profile at 180, control returns to 176 where the time is continually monitored. Once the current time matches a time in any stored affiliation profile at 180, affiliation procedures for registering an affiliation change are carried out at 184 and control returns to 176 to await the next match in affiliation time with current time.

The affiliation procedures carried out at 184 can include adding, deleting or substitution of an affiliation. In the example of two affiliations (A and B), the procedures will generally be to substitute one for the other. However, the invention is not to be considered so limited. For example, in an embodiment with three affiliations (A, B and C), the timed affiliation profile might designate that affiliation A is always active, B is active only on week days and C only active on weekends. In this case, Monday through Friday, both affiliations A and B would be active, while on Saturday and Sunday, both affiliations A and C would be active. Any suitable affiliation combination as might be useful to the user could be implemented in a subscriber unit consistent with the present invention.

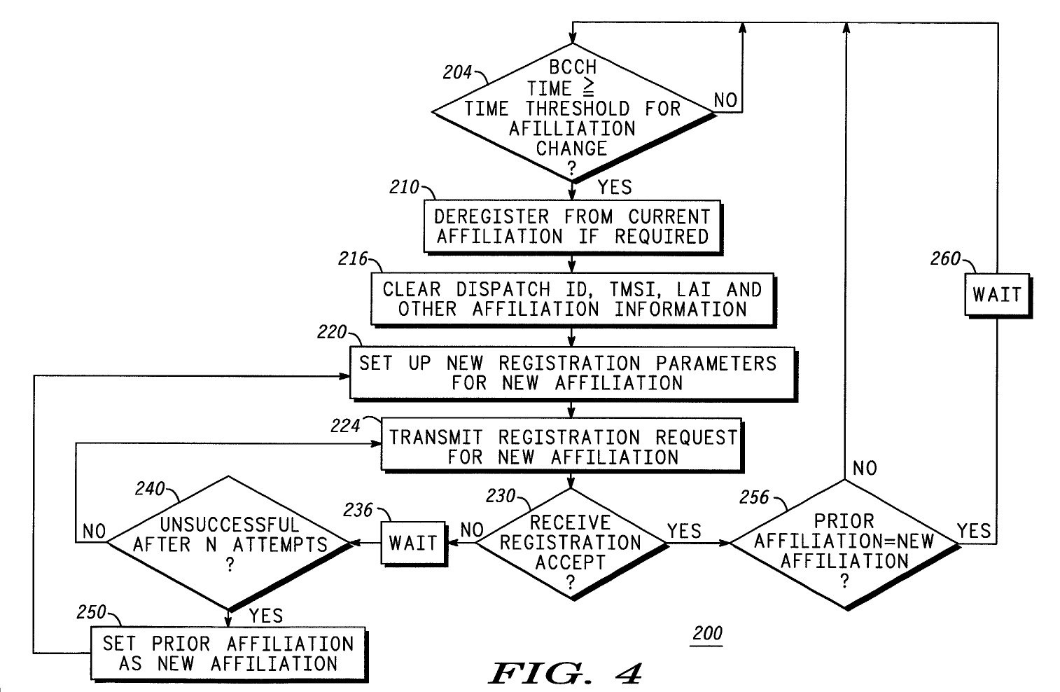

Referring now to FIG. 4, a flow chart 200 describes one more detailed techniques for changing affiliations in accordance with certain embodiments of the present invention. Error trapping and other implementation details have been omitted for clarity. Those having ordinary skill in the art will recognize many alternatives and modification to the exact process described without departing from the invention.

At 204, if the BCCH time (or other time available to the controller 112) is determined to be greater than or equal to a time designated for an affiliation change, control passes to 210. At 210, the current affiliation is deregistered. It should be carefully noted, however, that it might not always be required that a deregistration take place before another registration takes place. If deregistration is not required by the system or subscriber unit, deregistration 210 may be unnecessary, and should be thus considered optional and to be carried out only if needed.

After deregistering from the current affiliation at 210 (if necessary), the controller 112 clears current affiliation information at 216 and sets up new registration parameters for a new affiliation at 220. A registration request is then transmitted at 224 to set up a new registration for a new affiliation. If all goes well, a registration acceptance message is received at 230 and control returns to 204 where the next affiliation change time (and date) is awaited.

If no registration acceptance message is received at 230 after a reasonable wait time at 236, control returns to 224 for a retransmission of the registration request. The registration request can be retransmitted a number of times (N) until a predetermined number of attempts (N) have been made at 240. After N unsuccessful attempts at 240, control passes to 250 where the prior affiliation parameters are retrieved and control passes to 220. At 220, the prior affiliation is set up and control passes to 224 where the registration process is repeated in an attempt to reestablish the prior affiliation. In this manner, the failure to establish a new affiliation in accordance with the new affiliation parameters will not leave the user without communication. Many variations and modifications to this process are possible without deviating from the present invention. If the prior affiliation is reestablished after failure to reregister at 256, the system waits for a period of time at 260 and then attempts again to register with the new affiliation, assuming the time criteria for registration with the new affiliation is still valid at 204.

Those of ordinary skill in the art will recognize that the present invention has been described in terms of exemplary embodiments based upon use of a programmed processor such as controller 112. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those of ordinary skill in the art will also appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A communication device, comprising:
a wireless transceiver capable of operating with a plurality of affiliations;
a memory storing data associated with the plurality of affiliations and time information associated with each of the plurality of affiliations, the time information governing what time each of the plurality of affiliations is to be an active affiliation;
means for determining a current time; and
a controller which compares the current time with the time information to determine which of the plurality of affiliations is to be active, and which directs the transceiver to operate in accordance with the data associated with the active affiliation.

2. The communication device of claim 1, wherein the means for determining a current time comprises means for decoding a transmitted time received on a control channel.

3. The communication device of claim 1, wherein the means for determining a current time comprises a real time clock.

4. The communication device of claim 1, wherein the time information comprises time of day information and day information.

5. The communication device of claim 1, wherein two of the plurality of affiliations comprise affiliations with a single communication system using two NAMs.

6. The communication device of claim 1, wherein two of the plurality of affiliations comprise affiliations with two different communication systems.

7. The communication device of claim 1, wherein two of the plurality of affiliations comprise affiliations with two telephone numbers.

8. A multi-mode wireless telephone device, comprising:
a wireless transceiver capable of operating with at least two affiliations associated with at least two NAMs, the wireless transceiver operating to receive system information including time information transmitted over a control channel, the system information comprising at least time, day of week, month, and day of month;
a memory storing data associated with the plurality of affiliations and time information associated with each of the plurality of affiliations, the time information governing what time each of the plurality of affiliations is to be an active affiliation; and
a controller which compares the current time with the time information to determine which of the plurality of affiliations is to be active, and which directs the transceiver to operate in accordance with data associated with the active affiliation.

9. A method of timed affiliation for a wireless two way communication device, comprising:
monitoring a Broadcast Control Channel time until the Broadcast Control Channel time matches a timed affiliation time;
deregistering from a current affiliation;
clearing affiliation information from memory;
setting up new registration parameters for a new affiliation;
transmitting a request for the new affiliation;
if a new affiliation registration is accepted, awaiting a next Broadcast Control Channel time to match a timed affiliation time; and
if a new affiliation registration is not accepted:
re-transmitting a request for the new affiliation for up to N times; and
if the new affiliation registration is not accepted after N times, setting a prior affiliation as the new affiliation and transmitting a registration request to reset the affiliation to the prior affiliation.
